(19) United States
(12) Patent Application Publication
(10) Pub. No.: US 2007/0236537 A1
(43) Pub. Date: Oct. 11, 2007

(54) Fluid jet print module

(75) Inventors: Ray M. Karam II, Santa Barbara, CA (US); Georges Roussos, San Jose, CA (US)

Correspondence Address: SCHMEISER OLSEN & WATTS, 18 E UNIVERSITY DRIVE, SUITE # 101, MESA, AZ, 85201, US

(73) Assignee: Picosys Inc., Santa Barbara, CA (US)

(21) Appl. No.: 11/394,053

(22) Filed: Mar. 29, 2006

(51) Int. Cl. B41J 2/14

(52) U.S. Cl. 347/50

(57) ABSTRACT

A print module having nozzles which are centrally disposed in a nozzle face of the module is disclosed. The arrangement of the nozzles is symmetric with respect to fluidic paths in the nozzle plates or chamber plates. The connecting channels between chambers and nozzles can also be symmetric, allowing improved performance and uniformity of drop formation, drop size and drop velocity. The module does not suffer from fluid path differences between chamber plates, uses materials similar to the completed print module without the use of bonding agents such as adhesives, and greatly improves the jetting quality by using uniform or symmetric nozzles. In addition, the print module is slim, flat, robust, and can be slanted in order to increase resolution. A variety of fluids may be dispensed by the print module, including ink. The nozzles and nozzle arrangements in the print module can be made using advanced laser structuring.

### FIELD OF THE INVENTION

This invention generally relates to a print module formed from a number of structured, flat plates bonded together to make a fluidic print module including, for example, print modules made according to the “piezo-planar side-shooter” principle. The modules are equipped with planar piezoelectric actuators to eject a fluid (usually ink) through a plurality of nozzles or a single nozzle and can have electronic driving circuitry remote to the print module or attached to the print module. More specifically, this invention relates to print modules formed with a particular nozzle structure and a method for forming such structure using advanced laser-assisted material structuring techniques.

### BACKGROUND OF THE INVENTION

Print modules of the of the type described herein are used in digital printing machines, material deposition tools like office printers, wide format printers, franking or addressing machines, labeling machines, three-dimensional model printers, coaters, PCB-printers, DNA deposition tools, and the like. These modules can dispense a wide range of fluids but usually dispense ink, and therefore are generally known as ink-jet print modules.

The inherent resolution of a typical print module is relatively low, but can be increased by slanting the print module relative to the printing direction or by interleaving techniques using multiple print modules. The resulting print resolution can be up to several hundreds dots per inch (dpi).

The nozzle apertures in these modules can vary from a few microns up to hundreds of microns in diameter for a rounded nozzle, or for one side in the case of a square nozzle. Depending on design and application, the drop mass ejected can be between a few pico-liters (pl) up to thousands of pico-liters. The frequency of fluid ejection out of the nozzle can vary from a few Hz up to tens of kHz, depending on the drop size and fluid properties.

The number of nozzles per print module can vary from one to several hundred, depending upon the specific application. In order to achieve higher nozzle densities, the print modules can be stacked together to form print module blocks. For this purpose, a slim, flat print module design is advantageous because it helps to reduce space and cost.

Usually, the actuator is a piezoelectric/electrostrictive device of a flat design with electrodes deposited on both sides. Typically the actuator is attached to the actuation membrane by adhesive bonding or by soldering. In the case of a PZT actuator, voltage applied to the electrodes results in a change of its thickness and its lateral dimensions. Given that one side of the PZT is constrained by the membrane and the other side is free to grow in both the X and Y directions, the membrane-actuator sandwich bends. This bending is used to compress the liquid inside the chamber underneath the membrane, which is in fluidic connection to a nozzle. The pressure generated by the actuator is guided through the chamber to the nozzle, where it activates the ejection of a fluid droplet. A manifold is positioned on the print module to provide fluid to the chambers.

The chambers are usually formed by chemically etching flat plates (chamber plates) or by other structuring techniques using ordinary or photo-structurable glass, metal, plastic, or any other material that is chemically compatible with the fluids in use. Other structuring techniques include without limitation dry etching, sand-blasting, eroding, punching or laser ablation. The membranes necessary to attach the actuator can be formed by controlling the etch depth of chambers during the structuring process or by using thin plates (cover-plates) bonded on top of through-processed chamber plates. Chambers are usually arranged in pairs around flat center plates and bonded together to build the internal fluid passages.

Nozzles are usually structured using the same techniques described above for structuring the chambers. The nozzles are structured either in one of the chamber plates or on a center plate (nozzle plate) usually positioned between the two chamber plates. The nozzles are generally formed by bonding two plates together, one of them being previously etched (see U.S. Pat. No. 3,998,745). As a result of this technique, nozzle cross sections are usually rectangular or trapezoidal although, where silicon is used, nozzles can have a triangular shape (see U.S. Pat. No. 4,216,477 and U.S. Pat. No. 4,601,777.

Furthermore, since nozzles are usually made by etching a groove or u-channel into one plate and bonding it to a second plate, two factors can have a significant impact on their shape and size: a) the etch rate of materials or etch tools can vary significantly, leading to differences in etch depths; and b) the interfaces and the defining nozzle edges can vary in shape during the bonding process of the plate, leading to nonuniform edges and subsequently to non-uniform or misdirected jets.

Nozzles can also be built into the chamber plate they are communicating with, the two chamber plates generally having a center plate in between. This results in two nozzle rows per print module (i.e. one on each chamber plate) with identical flow characteristics. The disadvantage is that such a module can not be slanted in order to increase resolution, but can only be interlaced.

Advanced structuring techniques such as dry/wet etching, laser etching/ablation, or direct writing with a laser (see U.S. Pat. No. 6,783,920 and U.S. Pat. No. 6,932,933) can be useful for the precise structuring of components in devices such as print modules. A special nozzle plate fabricated from a separate flat piece by precise structuring and then mounted on the main body of the print module by adhesive bonding, for example, has been proposed as a possible approach to eliminating some of the non-uniform nozzle shape issues associated with more traditional fabrication techniques and for placing the nozzles in a single row, such that the module can be slanted to increase resolution. However, this approach generally gives rise to secondary deleterious problems associated with: a) the materials used to fabricate the nozzle plates; and b) the adhesives used to attach the nozzle plate to the print module body. The main difficulty with the materials used to fabricate such nozzles plates is their chemical incompatibility with the variety of fluids to be jetted. In addition, adhesives suffer from a lack of robustness/strength against solvents or extreme pH values. Adhesives also swell and cause the characteristics of the nozzle to change with time and eventually to fail.

Information relevant to attempts to address one or more of these problems can be found in the following references: U.S. Pat. No. 6,623,103; U.S. Pat. No. 6,367,911; U.S. Pat. No. 5,828,390; U.S. Pat. No. 5,825,382; U.S. Pat. No. 5,802,687; U.S. Pat. No. 5,757,402; U.S. Pat. No. 5,714,078; U.S. Pat. No. 5,668,583; U.S. Pat. No. 5,592,203; U.S. Pat. No. 4,015,271; German Patent No. 38 05 279; and German Patent No. DE 42 30 292. However, each one of these references suffers from one or more of the following disadvantages:

1. u-channel (capping channel) nozzles are formed onto the surface of a single plate and completed by affixing a capping plate. This leads in all cases to non-symmetric fluidic paths (e.g. paths of different lengths or shape/design), resulting in differing jetting characteristics (e.g. drop velocity) or different drop formation properties;

2. nozzles that are created by affixing two plates have inherently sharp corners, and therefore are not round or are non-uniform;

3. the use of a special nozzle plate or other design feature leads to problems arising from chemical incompatibility of the materials used with the variety of fluids to be jetted (e.g. inks), or requires the use of adhesives;

4. the low resolution print module can't be slanted in order to increase resolution; or

5. the design is bulky, complicated, difficult or costly to manufacture, or subject to failure during routine use.

### SUMMARY OF THE INVENTION

The present invention is directed to a print module that addresses one or more of the shortcomings in the related art and a method for making the module. The print module of the present invention is a fluid jet print module containing one or more nozzle-carrying members. Each nozzle-carrying member contains one or more nozzles which are centrally disposed in a nozzle face of the print module.

The nozzles may be uniform in shape and their arrangement can be symmetric with respect to the fluid path, such that the fluidic resistance to each nozzle is equal. The materials used to make the nozzle-carrying member can be similar or identical to that of the completed print module. The module contains means for supplying fluid to the print module and means for ejecting fluid from the print module and may be, for example, an edge-shooter type print module.

A nozzle-carrying member of the print module may contain one or more connecting channels for receiving fluid. Alternatively, the print module may include one or more chamber-carrying members having connecting channels for receiving fluid. In this embodiment, each nozzle in the nozzle-carrying member communicates with one of the channels in a chamber-carrying member, and the channels in the chamber-carrying members can be symmetric and equal in length. In addition, the chamber-carrying member can be composed of material similar or identical to that of the completed print module.

Additionally, one or more print modules of the invention can be combined to form a module block or may be part of a printing system. The modules of such a printing system may be moveable between an upright position and a slanted position, the slanted position increasing print resolution.

A method for structuring a nozzle-carrying member in a print module having centrally disposed nozzles is also described. Nozzles or nozzle channels, for example, can be made by exposing one or more nozzle plates to a laser beam directed perpendicularly or axially to the plate, thereby forming fluidic channels which are formed through, partially through or embedded in the nozzle plate when written. The nozzle-carrying members so structured may be made of photosensitive material.

Furthermore, a chamber-carrying member having a thin membrane can be made by exposing one or more chamber plates to a laser beam directed perpendicularly or axially to the plate, the thickness of the membrane being defined by an exposure stop of the laser.

The above-mentioned as well as other features and advantages of the present invention will be apparent from the following detailed description of the particular embodiments of the invention and illustrated in the accompanying drawings.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 is a perspective view of a print module system in accordance with one embodiment of the present invention, the print module including a nozzle-carrying member embedded between two side members carrying the chambers.

FIG. 2 is a schematic transverse cross section view of the print module of FIG. 1 showing the fluidic path of the even numbered chambers.

FIG. 3 is a schematic transverse cross section view of the print module of FIG. 1 showing the fluidic path of the odd numbered chambers.

FIG. 4 is a schematic transverse cross section view of the print module of FIG. 1 showing the fluid supply configuration in one embodiment of the present invention.

FIG. 5 is a schematic transverse cross section view of the print module of FIG. 1 showing the fluid supply configuration in one embodiment of the present invention.

FIG. 6 is a schematic transverse cross section view of the print module of FIG. 1 showing the fluid supply configuration in one embodiment of the present invention.

FIG. 7 is a schematic transverse cross section view of the print module of FIG. 1 showing the fluid supply configuration in one embodiment of the present invention.

FIG. 8 is a perspective view of a print module system in accordance with one embodiment of the present invention, the print module including a nozzle-carrying member embedded between two side members, each of the side members being composed of one chamber plate and one capping plate.

FIG. 9 is a schematic transverse cross section view of the print module of FIG. 8 showing the fluidic path of the even numbered chambers.

FIG. 10 is a schematic transverse cross section view of the print module of FIG. 8 showing the fluidic path of the odd numbered chambers.

FIG. 11 is a perspective view of a print module in accordance with one embodiment of the present invention, the print module including a center member embedded between two side members, the center member carrying both the nozzle and the chamber-structures.

FIG. 12 is a schematic transverse cross section view of the print module of FIG. 11 showing the fluidic path of the even numbered chambers.

FIG. 13 is a schematic transverse cross section view of the print module of FIG. 11 showing the fluidic path of the odd numbered chambers.

FIG. 14 is a perspective view of a print module in accordance with one embodiment of the present invention, the print module including two nozzle plates embedded between two side members.

FIG. 15 is a schematic transverse cross section view of the print module of FIG. 14 showing the fluidic path of the even numbered chambers.

FIG. 16 is a transverse cross section view of the print module of FIG. 14 showing the fluidic path of the odd numbered chambers.

FIG. 17 is a perspective view of a print module in accordance with one embodiment of the present invention, the print module including one nozzle plate and one capping plate embedded between two side members.

FIG. 18 is a schematic transverse cross section view of the print module of FIG. 17 showing the fluidic path of the even numbered chambers.

FIG. 19 is a transverse cross section view of the print module of FIG. 17 showing the fluidic path of the odd numbered chambers.

### DETAILED DESCRIPTION OF THE INVENTION

The following description presents embodiments of the invention representing various modes contemplated for practicing the invention. This description is not to be taken in a limiting sense but is made merely for the purpose of describing the general principles of the invention, whose scope is defined by the appended claims.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

As used herein; the term “adjacent to” when referring to a chamber-carrying member, nozzle-carrying member, capping structure, chamber plate, capping plate, or nozzle plate does not necessarily mean that the member or plate is immediately next to another member or plate, However, plates or members that directly contact each other are still adjacent to each other.

As used herein, the term “capping structure” is intended to mean a type of structure which, when added to a nozzle, chamber, nozzle plate, chamber plate, nozzle-carrying member, chamber-carrying member, or other print module component forms at least one complete fluid channel in a print module. Various types of structures could be used for this purpose, including without limitation a capping plate, cover plate, membrane, or combination thereof.

As used herein, the phrase “centrally disposed” when used to describe the nozzles in a nozzle-carrying member of a print module is intended to mean the nozzles are not in contact or contiguous with the edge of the nozzle-carrying member, including without limitation nozzles located at or near the center of the nozzle face.

As used herein, the phrase “chamber-carrying member” is intended to mean an assemblage of one or more plates, membranes, or other type of structures forming at least one chamber or chamber channel in a print module, including without limitation chamber plates and capping plates. The chambers or chamber channels can without limitation be located in the same member as the nozzles or nozzle channels or in a separate chamber-carrying member.

As used herein, the term “channel” is intended to mean an assemblage of one or more structures forming at least one portion of a fluid path in a print module, including without limitation nozzles, chambers, restrictors, connecting channels, wells, via-holes, and inlet holes.

As used herein, the term “cover plate” is intended to mean a capping structure or capping plate.

As used herein, the term “equal” when referring to the fluidic resistance to one or more nozzles in a print module, or to the length of a channel in a print module, is intended to mean that the fluidic resistance or the length of a channel is equal or near equal. The resistance in each nozzle, or the length of each channel, may be equal or substantially equal, for example.

As used herein, the phrase “laser ablation” or “direct laser ablation” when referring to structuring is intended to mean modifying the material in such a way as to create a character or structure in a previously uncharacteristic surface. Laser ablation, for example, can create a visible pattern in a surface without the need for further processing.

As used herein, the phrase “laser direct writing” when referring to structuring is intended to mean laser-assisted material modification which does not ablate the surface but rather modifies the material such that further processing is necessary to make the structured pattern apparent. This process is capable of creating patterns on or in materials directly without the need for lithography, masks or ablation. The features of the patterns formed can vary according to the parameters used for laser writing, including without limitation patterns formed through, partially through, or embedded in a surface when written and patterns having a high or low aspect ratio,

As used herein, the term “nozzle face” when referring to a nozzle-carrying member of a print module is intended to mean a droplet ejection face of the member. The nozzle face may be composed of multiple members including without limitation nozzle-carrying members, chamber-carrying members, and capping structures.

As used herein, the phrase “nozzle-carrying member” is intended to mean an assemblage of one or more plates, membranes, or other type of structures forming at least one nozzle or nozzle channel in a print module, including without limitation nozzle plates and capping plates. The nozzles or nozzle channels can without limitation be located in the same member as the chambers or chamber channels or in a separate nozzle-carrying member.

As used herein, the term “print module” is intended to mean the assemblage of structured members and the actuators. The structured members, including without limitation the inlet, manifold, connecting channels, chambers and nozzles, form the fluidic paths. The actuators are attached, in most cases externally, such that only the electrical interface is not present.

As used herein, the term “round” when referring to a nozzle or nozzle channel is intended to mean that the nozzle channel is round or near round in shape. A nozzle may be round or substantially round, for example.

As used herein, the term “structured” when referring to a chamber-carrying member or nozzle-carrying member is intended to mean that substructures are or have been formed within the member using one or more suitable techniques, including without limitation chemical etching, laser ablation, optical (laser-) etching, dry etching, sand-blasting, powered metallurgy, powered ceramics, drilling, punching, or laser direct writing.

As used herein, the term “symmetric” when referring to one or more structures in a print module to mean that the structures are symmetric or near symmetric in shape or arrangement. A nozzle, channel, or arrangement of nozzles may be symmetric or substantially symmetric, for example.

As used herein, the term “uniform” when referring to a nozzle or nozzle channel is intended to mean that the nozzle channel is uniform or near uniform in shape. A nozzle may be uniform or substantially uniform, for example.

Embodiments of the present invention generally relate to a print module that addresses one or more of the short comings in the related art. A variety of fluids may be dispensed by the print module, including without limitation ink.

More specifically, the embodiments of present invention include a nozzle that is centered in a nozzle plate or nozzle-carrying component located in the main body of the print module, a nozzle which may not require a second plate to cap off the nozzle channel. The nozzles can be round, and there may be greater uniformity in the nozzles and in the fluidic paths to the nozzles. In addition, the nozzle plate may not transfer the jetting fluid from left and right chamber plates to asymmetrically located nozzles. Furthermore, only one type of material can be used to form the print module such as, without limitation, glass or glass ceramic. In addition, the use of adhesives may be eliminated, allowing a maximum spectrum of fluids to be jetted and increasing the ease of operation by reducing or eliminating the number of air traps. Yet further, the print module can be slim, flat, and robust, and the nozzles can be placed in a single row such that the module may be slanted in order to increase resolution. Additionally, the simplified design of the print module facilitates manufacturing, thus lowering rejection rates and production costs.

The advanced laser structuring in the nozzle plate can be achieved by laser etching/ablation processes using materials like ordinary glass, fused silica, quartz, silicon, metals, plastics and the like, or by direct writing with a laser into photosensitive glass ceramic material or quartz, followed by developing and etching with diluted HF. Laser direct writing provides modification, subtraction, or addition processes capable of creating patterns of materials directly on substrates without the need for lithography or masks.

The nozzles can be formed in the center of the center plate (nozzle plate) of a print module, such that their arrangement is totally symmetric with respect to the chamber plates. Using laser etching/ablation or direct writing with a laser, nozzle channels can be written such that their cross sections may be symmetrical and uniform, i.e., rectangular, square or round, rather than triangular, or trapezoidal, as is the case when conventional etching techniques are used. Furthermore, the connecting channels between chambers and nozzles can be totally symmetric, allowing improved performance and uniformity of drop formation, drop size and drop velocity. In addition, dead ends, usually created by through holes, can be avoided in the subject invention, allowing for easier print module priming.

### EXAMPLE 1

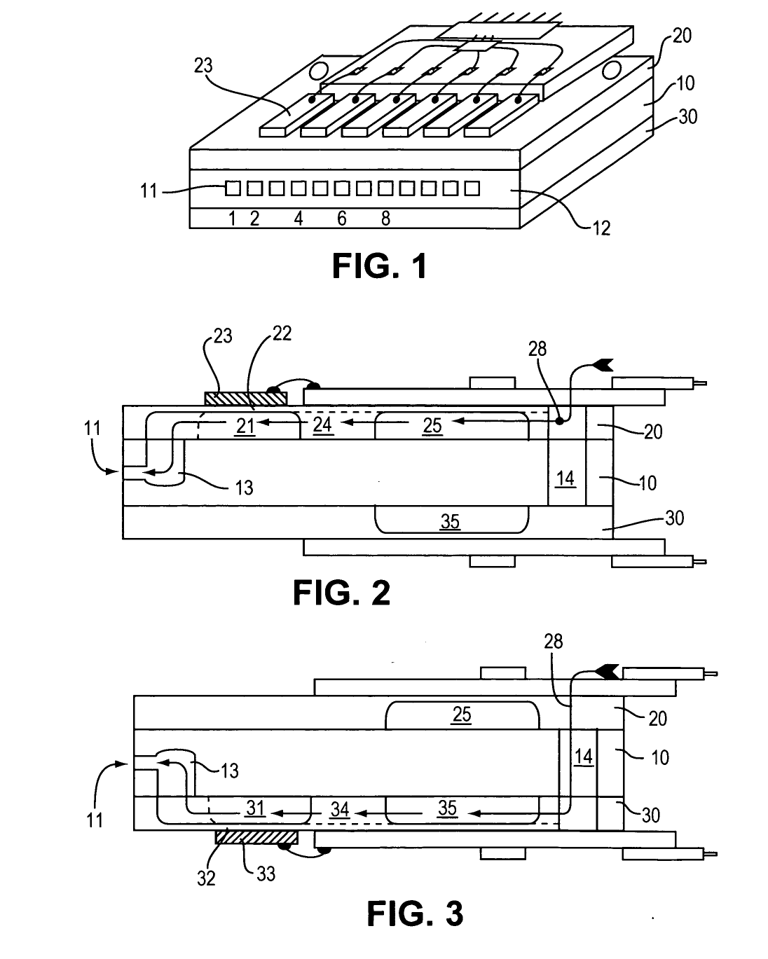

The print module is composed of three structured components: a nozzle-carrying member (10) embedded between two chamber-carrying side members (20) and (30), as illustrated in FIGS. 1 to 7). The nozzle face (12) of the nozzle-carrying member (10) carries the nozzles (11), which are built in one row in the center of the nozzle-carrying member as shown in FIG. 1. The total number of nozzles is usually 2n, where n is an integer, but could be any other number as well.

FIGS. 2 and 3 show the fluid paths of the print module. The embedded nozzles (11) are connected to wells (13) in the nozzle-carrying member (10). The wells are structured on both sides of the nozzle-carrying member in an alternating and opposing pattern with respect to the nozzles, the even numbered nozzles form one nozzle group connecting to wells facing the top side chamber-carrying member (20), as shown in FIG. 2, and the odd numbered nozzles form a second nozzle group connecting to wells facing the bottom side chamber-carrying member (30), as shown in FIG. 3. The wells (13) connect the nozzles to chamber arrays (21) and (31) built into the top (20) and bottom (30) side members respectively. The arrangement of the nozzles is symmetric with respect to the fluid path, such that the fluidic resistance is equal to each nozzle.

The chambers (21) and (31) are structured on the inner sides of the side members, facing towards the nozzle-carrying member. They carry thin membranes (22) and (32) that are coupled to external piezoelectric actuators (PZT's) (23) and (33) as shown in FIGS. 2 and 3 respectively.

The number of chambers within one array (top or bottom in this particular arrangement) is usually 2n/2, but it can be any other number as well. The chambers within one array are usually arranged in rows but other types of arrangements are possible.

The chambers (21) and (31) are connected to the fluid supply system through channels (24) and (34), called restrictors, which are etched into the side members or the nozzle-carrying member.

The fluid supply system can be made in a variety of configurations, including without limitation:

a) two wells (25) and (35) that are etched into the side members (20) and (30) and connected to each other through a via-hole (14) and to at least one fluid inlet hole (28) built into a side member (FIG. 2 and FIG. 3);

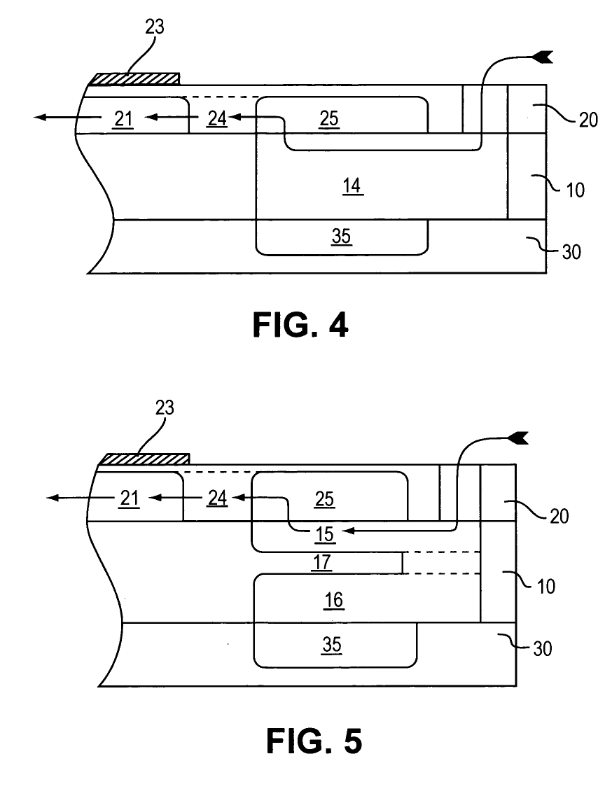

b) two wells (25) and (35) that are etched into the side members and a common well (18) etched in the nozzle-carrying member (10) (FIG. 4);

c) two wells (25) and (35) that are etched into the side members and two wells (15) and (16) etched into the nozzle-carrying member (10) and separated from each other by a diaphragm (17) (FIG. 5);

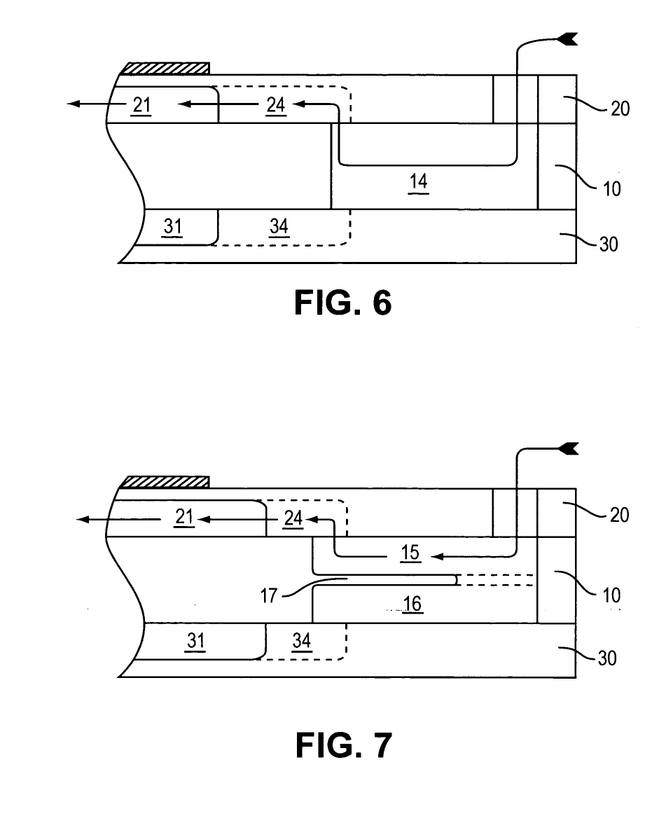

d) one common well (18) in the nozzle-carrying member (10), that is directly connected to the chambers (21) and (31) by overlapping with the restrictors (24) and (34) (FIG. 6); or

e) two wells (15) and (16) built in the nozzle-carrying member, that are separated by a diaphragm (17) and that are directly connected to the chambers (21) and (31) in the side members by overlapping with the restrictors (24) and (34) (FIG. 7).

The PZT's can be electrically connected to driving circuitry members using a variety of techniques, including without limitation wire bonding, adhesive bonded or soldered lead frames, or by adhesive bonded or soldered flex cables. The driving circuitry members can be mounted on the print module or can be externally attached.

### EXAMPLE 2

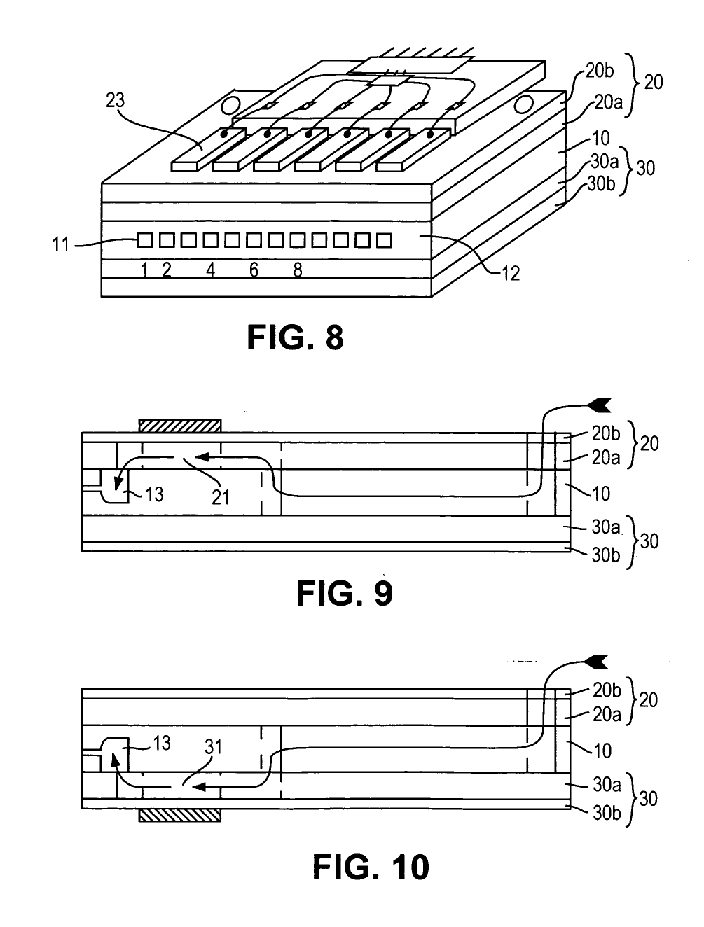

The print module is composed of five components: a nozzle-carrying member (10) embedded between two chamber-carrying side members (20) and (30), each of the side members being composed of one chamber plate (20a) and (30a) respectively, and one capping plate (20b) and (30b) respectively, as illustrated in FIGS. 8 to 10.

The nozzles (11) are disposed in the face center of the nozzle-carrying member composed of a nozzle plate. The chambers of this device are etched through in chamber plates (20a) and (30a) in an alternating top-bottom pattern, respectively, whereas the diaphragms are provided two thin cover plates (20b) and (30b). The wells are structured on both sides of the nozzle-carrying member (10) in an alternating pattern with respect to the nozzles, the even numbered nozzles connecting to wells facing the top side member (20), as shown in FIG. 9, and the odd numbered nozzles connecting to wells facing the bottom side member (30), as shown in FIG. 10. The wells (13) connect the nozzles to chambers arrays (21) and (31) built into the top (20) and bottom (30) side members respectively.

All other structural elements can be similar to those as described in Example 1.

### EXAMPLE 3

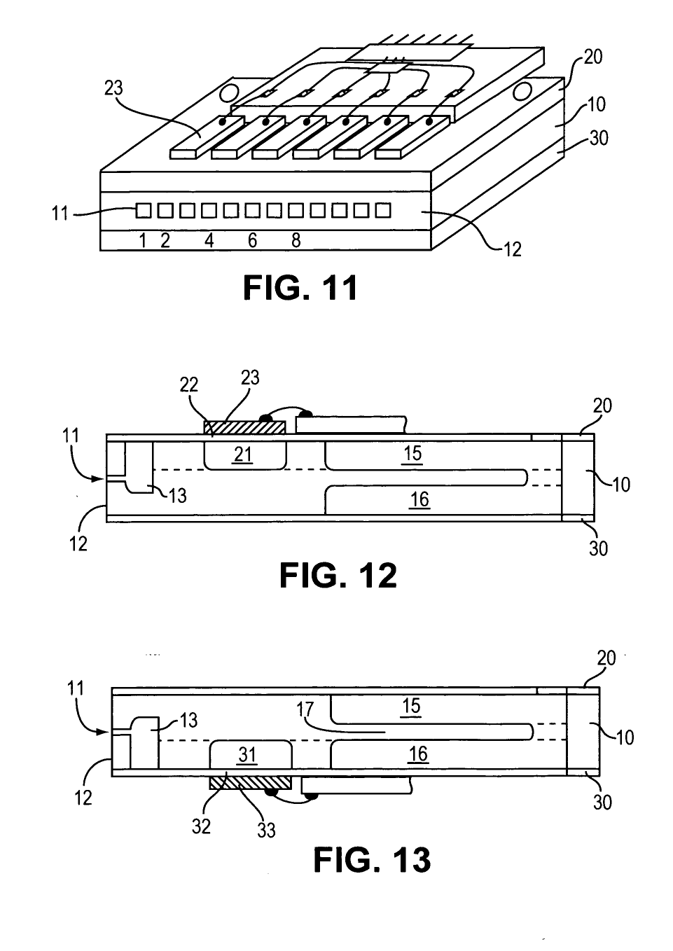

The print module is composed of three components: a nozzle- and chamber-carrying member (10) embedded between two side members (20) and (30), as illustrated in FIGS. 11 to 13. The entire channel structure of this device is built into a single plate (10). The nozzles (11) are centrally disposed in the nozzle face (12) of the center member. The chambers (21), (31), the wells (13) and the manifolds (15), (16) are build on both sides of the center member. The two side members (20) and (30) are cover plates providing the chamber diaphragms (22) and (32) and covering the manifolds (15) and (16), as shown in FIGS. 12 and 13, respectively. The fluid supply is provided by the two manifolds (15) and (16) separated from each other by a diaphragm (17). A fluid supply built out of one manifold (18), as depicted in FIG. 4, is also possible.

All other structural elements can be similar to those described in Example 1.

### EXAMPLE 4

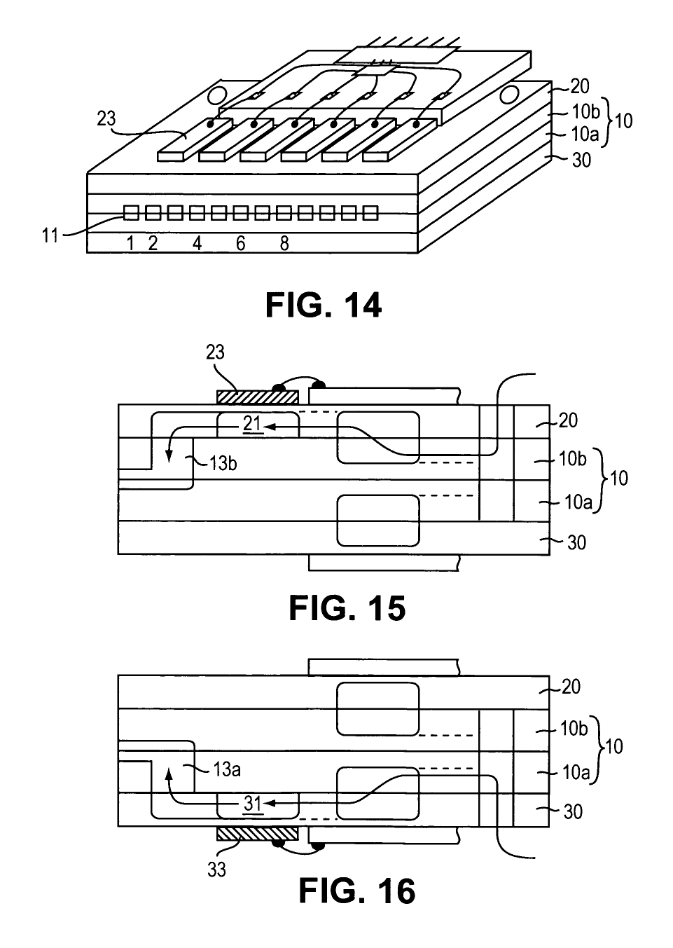

The print module is composed of four components: a nozzle-carrying member (10) composed of two nozzle plates (10a) and (10b) embedded between two chamber-carrying side members (20) and (30), as illustrated in FIGS. 14 to 16). The nozzles are formed by structuring each nozzle plate with one half the nozzle depth.

Nozzles are fluidically connected to the side members by means of through-holes (13a) and (13b) built into the nozzle-carrying members (10a) and 10b). Every other nozzle is supplied with fluid from alternating sides as shown in FIGS. 15 and 16.

Though-holes (13a) and (13b) connect nozzles to chambers (21) and (31) built into the side members (20) and (30), respectively.

All other structural elements can be similar to those described in Example 1.

### EXAMPLE 5

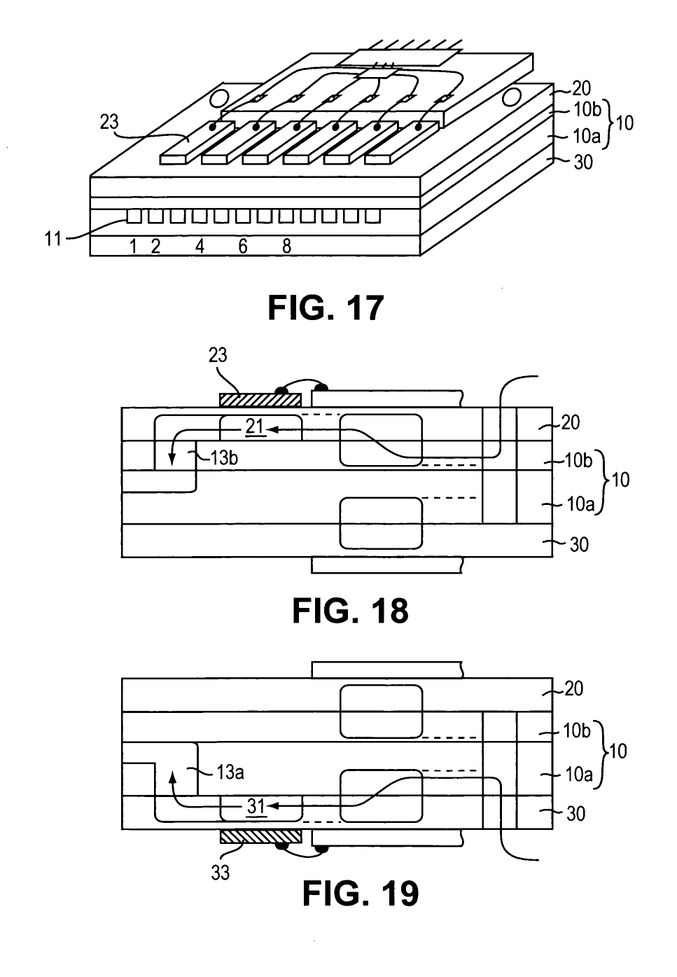

The print module is composed of four components: a center nozzle-carrying member (10) composed of a nozzle plate (10a) and a capping plate (10b) embedded between two chamber-carrying side members (20) and (30), as illustrated in FIGS. 17 to 19). The nozzles are formed by structuring one center plate, the nozzle plate (10a), which is thicker than the other center plate, the capping plate (10b) by the amount of the nozzle height, enabling the nozzles to be centered within the nozzle-carrying member (10).

Nozzles are fluidically connected to the side members by means of through-holes (13a) and (13b) built into the respective center nozzle plates (10a) and (10b). Every other nozzle is supplied with fluid from alternating sides as shown in FIGS. 17 and 19.

Though-holes (13a) and (13b) connect nozzles to chambers (21) and (31) built into the side members (20) and (30), respectively.

All other structural elements can be similar to those described in Example 1.

The print module of EXAMPLES 1-5 can be readily, accurately, and reproductively structured and assembled in both small and large scale environments.

The nozzles can be formed by laser direct ablation of a nozzle-carrying member using, for example, a CO₂ laser operating in pulse or continuous mode. Laser direct ablation can be performed on a number of different materials including without limitation ceramics, glass quartz, silicon, metals and plastics. Alternatively, laser direct writing can be used in which a UV or near UV laser is used to structure the print module members in photosensitive glass ceramic or quartz material followed by developing and etching with diluted hydrofluoric acid. After laser structuring the nozzles channels are cleaned and bonded together to form the print module.

The fluid inlets, chambers and channels in the chamber-carrying members can be structured using a variety of techniques using ordinary or photo-structurable glass, metal, plastic, or any other material that is chemically compatible with the fluids in use, including without limitation the jetting fluids (e.g. inks). Suitable structuring techniques include without limitation chemical etching, dry etching, sand-blasting, eroding, punching, laser direct writing or laser ablation. Very thin membranes can be formed in the channels by laser direct writing, where the thickness may be defined by the exposure stop of the laser rather than an etch stop.

The nozzles in the nozzle-carrying member can be aligned with the corresponding channels in each of the individual chamber-carrying members by use of the appropriate fiducials, alignment tooling and computer controlled automation techniques. The chamber-carrying members can then be bonded to the nozzle-carrying member using a variety of techniques including, without limitation, anodic bonding, diffusion bonding, adhesive bonding, electro-fusion bonding, or atomic stiction bonding.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, the number, shape, or position of the nozzles on the nozzle face may vary and print modules could be made without capping structures or chamber-carrying members.

What is claimed is:

1. A fluid jet print module having means for supplying fluid to the print module and means for ejecting fluid from the print module, the fluid jet print module comprising at least one nozzle-carrying member having at least one nozzle, wherein the at least one nozzle is centrally disposed in a nozzle face of the nozzle-carrying member.

2. The print module of claim 1, wherein the at least one nozzle is at least one of uniform and symmetric.

3. The print module of claim 2, wherein at least one nozzle channel in the at least one nozzle is round in cross section.

4. The print module of claim 1, wherein the at least one nozzle-carrying member further comprises at least one connecting channel formed therein for receiving fluid.

5. The print module of claim 1, further comprising at least one chamber-carrying member having at least one connecting channel formed therein for receiving fluid, wherein the at least one nozzle in the at least one nozzle-carrying member communicates with a respective one of the at least one channel in the at least one chamber-carrying member.

6. The print module of claim 5, comprising at least two chamber-carrying members having at least two connecting channels formed therein.

7. The print module of claim 6, wherein the at least two connecting channels are at least one of symmetric and equal in length.

8. The print module of claim 1, further comprising at least two opposing channels, wherein the at least two channels are connected to at least two nozzles, the relative position of the at least two nozzles is symmetric with respect to the at least two channels, and the fluidic resistance from the at least two channels to the at least two nozzles is equal.

9. The print module of claim 1, wherein the module comprises an assemblage of structured members comprising similar or identical materials, the assemblage comprising at least one of a nozzle-carrying member and a chamber-carrying member.

10. The print module of claim 1, wherein the module is an edge-shooter type print module.

11. A module block comprising at least one print module according to claim 1.

12. A printing system comprising at least one print module according to claim 1.

13. The printing system of claim 12, the at least one print module being moveable between an upright position and a slanted position, wherein the slanted position increases print resolution.

14. A method for structuring at least one nozzle-carrying member in a print module, wherein at least one nozzle is centrally disposed in the at least one nozzle-carrying member, the method comprising exposing at least one nozzle plate to laser irradiation wherein a laser beam is directed perpendicularly or axially to the member, thereby forming at least one fluidic channel which is formed through, partially through or embedded in the at least one nozzle plate.

15. The method of claim 14, wherein the at least one nozzle-plate comprises photosensitive material.

16. The method of claim 14, wherein the at least one nozzle is at least one of uniform and symmetric.

17. The method of claim 16, wherein the at least one channel is round in cross section.

18. The method of claim 13, wherein the at least one nozzle plate is structured using at least one of direct laser ablation and laser direct writing.

19. A print module comprising at least one nozzle-carrying member formed according to the method of claim 14.

20. A method for structuring at least one chamber-carrying member in a print module, wherein at least one chamber in the at least one chamber-carrying member comprises at least one thin membrane, the method comprising exposing at least one chamber plate to laser irradiation wherein a laser beam is directed perpendicularly or axially to the chamber plate, thereby forming at least one thin membrane wherein the thickness of the membrane is defined by an exposure stop of the laser.
